(19) United States
(12) Patent Application Publication
(10) Pub. No.: US 2004/0254994 A1
(43) Pub. Date: Dec. 16, 2004

(54) Process of tracking whether an E-Mail has been read and links accessed using client based software

(76) Inventors: Donato S. Diorio, Hartland, WI (US); Igor Petrenko, Pewaukee, WI (US)

Correspondence Address: JEFFREY FURR, 253 N. MAIN STREET, JOHNSTOWN, OH, 43031, US

(21) Appl. No.: 10/710,039

(22) Filed: Jun. 14, 2004

Related U.S. Application Data
(60) Provisional application No. 60/320,270, filed on Jun. 13, 2003.

(51) Int. Cl. G06F 15/16

(52) U.S. Cl. 709/206

(57) ABSTRACT

A process by which the receiving and opening of E-mail as well as connecting to links in that E-Mail are tracked and provided to the person who sent the E-mail. It is a system that attaches a GRAPHIC file to the E-mail that will send responses to the system when the file is receive, opened and read as well as when any links in that E-mail are accessed.

### CROSS REFERENCE TO RELATED APPLICATIONS

This application is a non-provisional application claiming the priority date of Provisional Application 60/320,270 filed Jun. 13, 2003

### BACKGROUND OF INVENTION

1. Field of the Invention

This invention relates to the art of tracking whether or not an E-mail has been read and links in that E-mail have been accessed.

2. Description of Prior Art

Historically, people made contact with others through the use of the telephone or mail. The phone allowed someone to know if and when they made contact, Through the use of certified mail you could also make sure that someone received your letter or document. Now one of the most common ways of communication is through the use of the Internet through E -Mail.

It is very important and advantageous to someone especially in marketing to know if, when and how many times a person has read an E-mail.

It is difficult at times to know if someone has read or received your E-mail. Many times this is done on faith. There are E-mail tracking systems but most of these require the use of Application Service Providers (ASPs) or a special Internet Service Provider (ISP). These ASP add addition levels of complexity to the process as well as allowing the recipient of the E-mail to turn off the tracking by simply have the ASP web address turned off through their firewall system.

The need to track the receipt and opening of E-mail without the use of an ASP shows that there is still need for improvement in the art.

### SUMMARY OF INVENTION

The object of the present invention is to provide a method for tracking the receiving, opening and reading of E-mail by a recipient as well as tracking the opening of any links contained within the E-mail. The invention is a process by which the receiving and opening of E-mail as well as connecting to links in that E-Mail are tracked and provided to the person who sent the E-mail.

The current invention is a system that attaches a GRAPHIC file to the E-mail that will send responses to the system when the file is receive, opened and read as well as when any links in that E-mail are accessed.

Definitions:

Whois: A program that will provide the owner's name of any 2nd-level domain name.

ASCII: American Standard Code for Information Interchange

WWW: World-Wide Web

GUI: Graphical User Interface

HTML: Hypertext Markup Language URL: Uniform Resource Locator.

### BRIEF DESCRIPTION OF DRAWINGS

Without restricting the full scope of this invention, the preferred form of this invention is illustrated in the following drawings:

FIG. 1—Display a User interacting with the Internet.

FIG. 2—Displays an overview of the system.

FIG. 3—Displays the Dashboard of the system.

FIG. 4—Displays the Sync Option.

FIG. 5—Displays the Main Screen of the System FIG. 6—Displays the links activated.

FIG. 7—Displays the IP addresses of where the E-mails were read.

FIG. 8—Displays the reading pattern.

FIG. 9—Shows how to set up the system.

### DETAILED DESCRIPTION

The preferred embodiment of the invention is described below. The current invention uses Internet communications tool, browser, ISP (Internet Service Providers), embedded web-site, URL, protocols and languages that are known to one skilled in the art and therefore not disclosed here in detail.

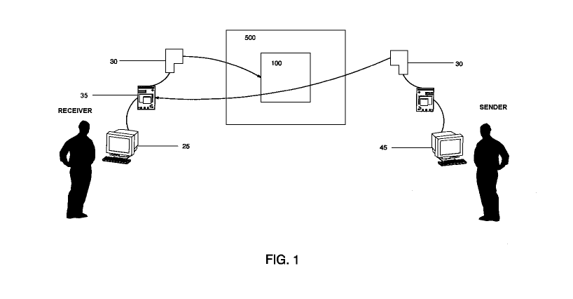

FIG. 1 illustrates a functional diagram of how a User 10 uses a computer 25 connected to the Internet 500. The computer 25 can be connected directly through a communication means such as a local Internet Service Provider, often referred to as ISPs, or through an on-line service provider like CompuServe, Prodigy, American Online, etc.

The Users 10 contacts the Internet 500 using an informational processing system capable of running an HTML compliant Web browser. A typical system that is used is a personal computer with an operating system such as Windows 95, 98 or ME or Linux, running a Web browser. The exact hardware configuration of computer used by the User 10 and the brand of operating system is unimportant to understand this present invention.

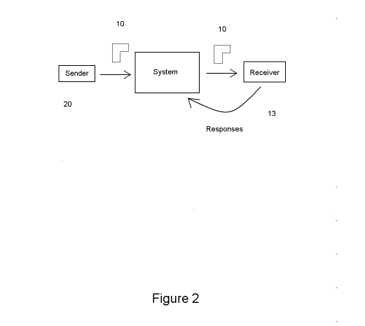

As shown in FIG. 2, the computer application that includes the user interface for this invention will be henceforth be referred to as “the system 1.” The system 1 focuses on attaching code to an E-mail 10 that is sent for the sender 20 to the receiver 30. The system can be used with any client or server based email system that utilizes a SMTP server to send email.

The System 1 is notified when a receiver 20 receives the E-mail, opens the E-Mail and connects to any links in the E-mail. The system 1 that attaches a GRAPHIC file to the E-mail that will send responses to the system when the file is receive, opened and read as well as when any links in that E-mail are accessed. This information is sent through the Internet 500 although it would also work well through an Intranet as well.

The System 1 is not dependant on a centralized system on an ASP or ISP. It can be located on the User's computer.

In the preferred Embodiment the system 1 will track this information to make it useful and convenient to the person using the system to track the E-mails. The system 1 would have various functions to assist in this.

The system 1 will maintain a database of names, addresses, phone numbers, company as well as user defined fields. The user can import the information from other databases and sources. The system 1 will also store the numbers associated with the E-mails that have been sent out to a specific individual or a specific company.

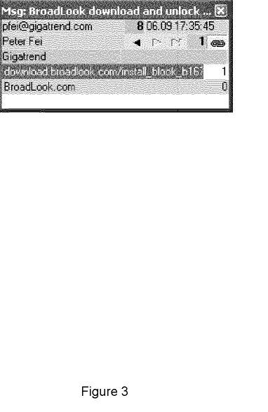

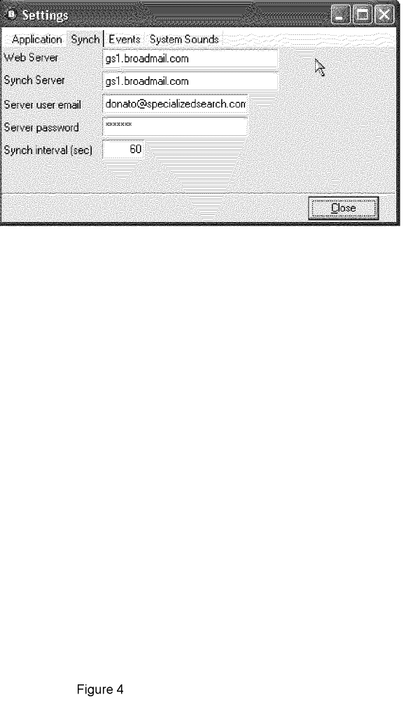

FIG. 3 shows a dashboard display of the system 1. It is a quick display that shows if the E-mail has been read and how many times as well as if a link such as to “Broadlook.com” has been accessed through the E-mail.

FIG. 4 displays a Sync window. In the preferred embodiment, the system 1 will allow the user to specify a specific amount of time to sync the data with the display window. If a user sets the sync option too big the user may miss information. If the sync is set too low then it will increase the processing load on the computer. In most cases the optimal sync time will be between 30 and 60 seconds.

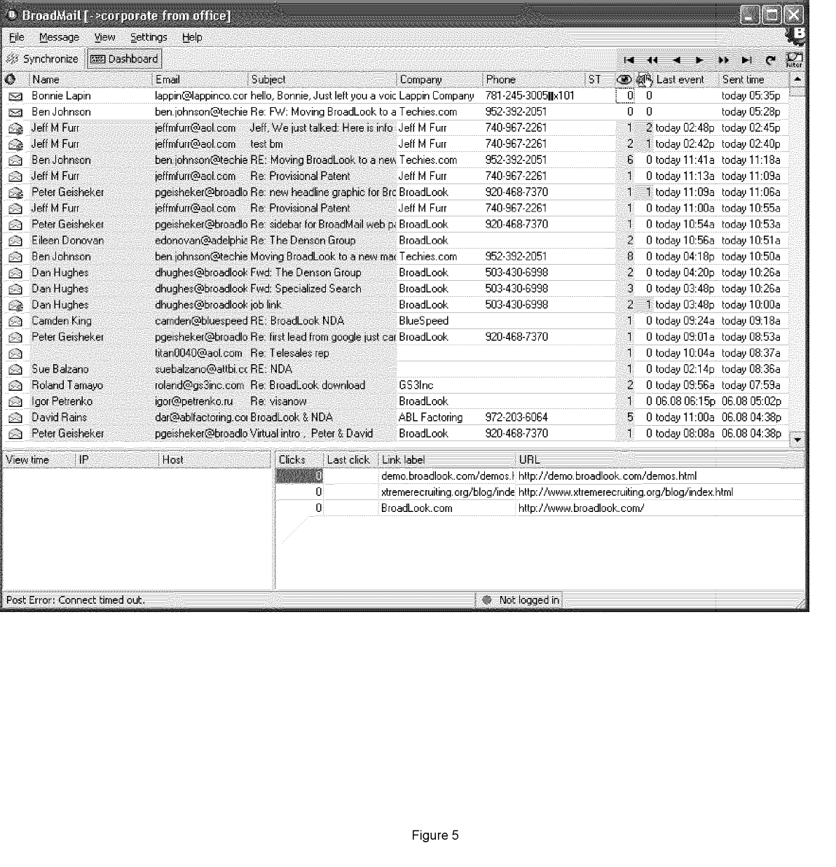

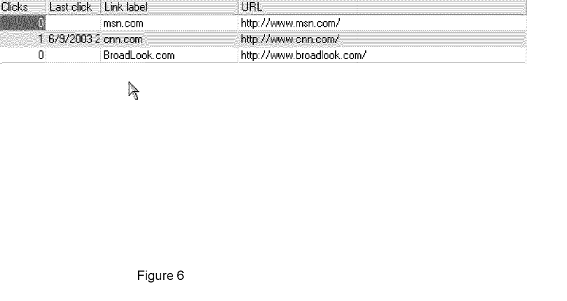

FIG. 5 is a sample of a main screen for the system 1. The screen shows the name of the person that the E-mail was sent to, their E-mail address, the subject of the E-mail, the company that it was sent to, phone number of the person it was sent to, the number of times it has been read, how links have been activated, the last time the E-mail was read or a link activated and the time the E-mail was sent. The screen is color coded for a better display as to who has and has not opened at E-mail or Link.

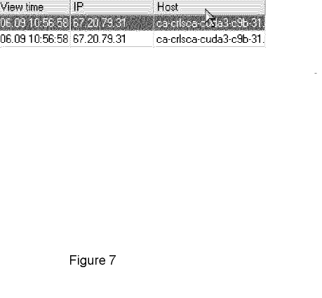

FIG. 6 is a more detailed display showing which links the receiver has activated and when. As shown in FIG. 7, in the preferred embodiment the system can track and show the IP addresses of where the E-mail was read. This allow the user to track if the email was forwarded to other locations.

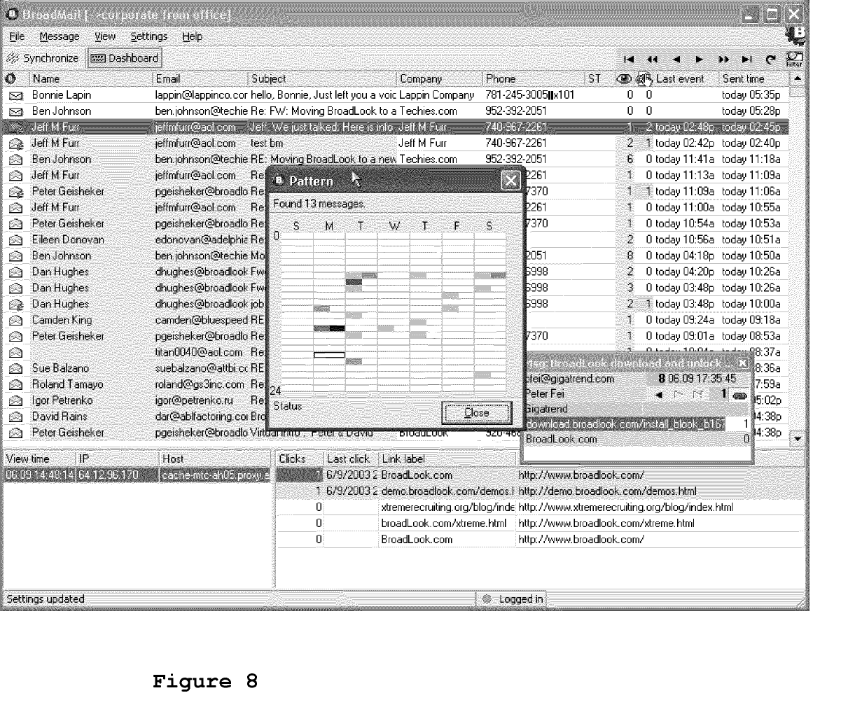

The system 1 will track the reading patterns of the receivers of the E-mails. This pattern can be outputted in graphic form such as shown in FIG. 8.

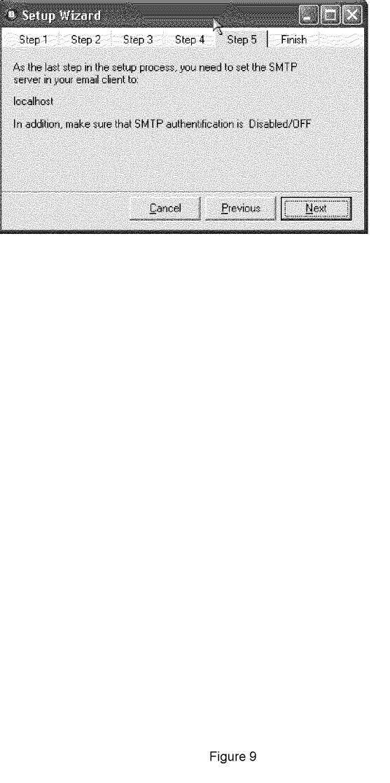

Operations In a standard computer configuration, the system 1 is set up by setting the SMTP server in the E-mail client to “localhost” with the SMTP authentification being disabled as shown in FIG. 9. The E-mail client will send the E-mail to the system 1 which will then send it on to the receiver through the Internet.

Advantages

The previously described version of the present invention has many advantages. The System has no need for a centralized ISP or ASP and can be used any where by the user.

While an internet server IS needed, it can be hosted on the clients own machine. The added advantage is the all parts of the email message sent will show as originating from the same machine and IP address.

Although the present invention has been described in considerable detail with reference to certain preferred versions thereof, other versions are possible. Therefore, the point and scope of the appended claims should not be limited to the description of the preferred versions contained herein.

1. A method to track E-mail messages comprising:
attaching a graphic file to an E-mail, having said graphic file sending responses to sender when said file is receive, opened and read.

2. A method according to claim 1 further comprising sending responses when any links in said E-mail are accessed.

3. A method according to claim 1 further comprising sending responses anytime when any links in said E-mail are accessed.

4. A method according to claim 1 further comprising sending responses anytime when the file is receive, opened and read.

5. A method according to claim 1 further comprising having a system tracking said responses

6. A method according to claim 5 further comprising having said system tracking said responsesgraphically.

7. A method according to claim 1 further comprising having sending said responses through the Internet.

8. A method according to claim 1 further comprising having sending said responses through an Intranet.

9. A method according to claim 6 further comprising having a dashboard display.

10. A method according to claim 6 further comprising having the user to specify a specific amount of time to sync the response data with the graphic display.

11. A method according to claim 5 further comprising having said system storing information on a database.

12. A method according to claim 11 further comprising having said database stores demographic information.

13. A method according to claim 5 further comprising having setting the SMTP server in the E-mail client to “localhost” with the SMTP authentification being disabled on the computing device receiving said E-mail.

14. A method according to claim 5 further comprising tracking the reading patterns of the receivers of the E-mails.

15. A method according to claim 14 further comprising having said patterns being outputted in graphic form.

16. A method according to claim 14 further comprising having a screen showing the name of the person that the E-mail was sent to, the person's E-mail address, the subject of the E-mail, the company that it was sent to, the phone number of the person the E-mail was sent to, the number of times the E-mail has been read, if the links in said E-mail have been activated, the last time the E-mail was read, the last time a link from said E-mail was activated and the time the E-mail was sent.

17. A method according to claim 16 further comprising having said screen color coded.

18. A method to track E-mail messages comprising:
attaching a graphic file to an E-mail, having said graphic file sending responses to sender when said file is receive, opened and read, sending responses anytime when any links in said E-mail are accessed, sending responses anytime when the file is opened, having a system tracking said responsesthat is loaded on a computing means connected to a communication means and having said system tracking said responsesgraphically.

19. A method according to claim 18 further comprising having sending said responses through the Internet through the an internet connection to said computing means.

20. A method according to claim 19 further comprising having setting the SMTP server in the E-mail client to “localhost” with the SMTP authentification being disabled on the computing device receiving said E-mail.
